(19) United States
(12) Patent Application Publication
(10) Pub. No.: US 2010/0145802 A1
(43) Pub. Date: Jun. 10, 2010

(54) Product Distribution Network

(76) Inventors: David Nowacek, San Antonio, TX (US); Charles Nowacek, San Antonio, TX (US)

Correspondence Address: JACKSON WALKER, L.L.P., 112 E. PECAN, SUITE 2400, SAN ANTONIO, TX, 78205, US

(21) Appl. No.: 12/295,831

(22) PCT Filed: May 12, 2008
(86) PCT No.: PCT/IB08/03762

§ 371 Date: Oct. 2, 2008

Related U.S. Application Data
(60) Provisional application No. 60/928,810, filed on May 11, 2007.
(60) Provisional application No. 61/021,715, filed on Jan. 17, 2008.

(51) Int. Cl. G06Q 30/00; G06Q 50/00

(52) U.S. Cl. 705/14.51; 705/34; 705/27

(57) ABSTRACT

A product distribution network enables a user to easily order remote products. The user may encounter an advertisement and send a Product Request Message (PRM), identifying the advertiser or the product, to a service provider. The service provider may then charge a fixed-rate premium for the message and instruct a product provider to deliver the product. In one embodiment, a user may hear a song on the radio and send a short messaging service (SMS) text message to a mobile phone service provider. The SMS message may include the call letters of the radio station. The service provider may then access the radio station's play list to identify the song currently playing. The service provider instructs an online music service to deliver the song to the user. The user is then charged a fixed premium rate for the text message, which is divided appropriately among the parties.

This application is a U.S. national stage entry of PCT application PCT/IB2008/003762, entitled “Product Distribution Network,” filed May 12, 2008, which claims the benefit of U.S. provisional application 60/928,810, entitled “A Method for Queuing and Retrieving Remote Content via Short Message Service,” filed May 11, 2007 and U.S. provisional application 61/021,715, entitled “Product Distribution Network,” filed Jan. 17, 2008.

### BACKGROUND

This specification relates to the field of product distribution networks and more particularly to a method, device and network for queuing and delivering remote products.

Providers of services such as mobile telephone networks may enable users to send messages such as short messaging service (SMS) messages, also referred to herein as text messages. Text messages are routed to a destination, and in some cases, the service provider may charge a fixed-rate premium for text messages sent to a specific destination. For example, an audience viewing a popular competitive television program may use text messages to vote for a winner, and the service provider may charge a fixed-rate premium for those messages that is higher than the cost of a standard text message.

### BRIEF DESCRIPTION OF THE DRAWINGS

FIG. 1 is a network diagram of an embodiment of a product distribution network (PDN);

FIG. 2 is a network diagram of an embodiment of a PDN wherein a radio station is a product advertiser;

FIG. 3 is a network diagram of an embodiment of a product distribution network wherein a radio station is a product advertiser and a product provider;

FIG. 4 is a network diagram of an embodiment of a PDN for distributing physical goods;

FIG. 5 is a block diagram of an embodiment of a request handling device;

FIG. 6 is a flow diagram showing an embodiment of a method of processing requests and delivering remote products;

FIG. 7 illustrates exemplary text messages for use with a PDN;

FIG. 8 illustrates exemplary metadata fields for use with a PDN;

FIG. 9 is a network diagram of an embodiment of a PDN illustrating separate delivery of metadata and products; and

FIG. 10 is a flow diagram showing an embodiment of a method of permitting a user to purchase metadata separately from a product.

### SUMMARY OF THE DISCLOSURE

In one aspect, a disclosed product distribution network (PDN) may enable a user to order remote products. The user may encounter an advertisement and send a Product Request Message (PRM), identifying the advertiser or the product, to a PDN provider. The PDN provider may then charge a premium for the PRM and instruct a product provider to either deliver the product or make the product available. In one embodiment, a user may hear a song on the radio and send a PRM such as a short messaging service (SMS) message, also referred to herein simply as a text message to a PDN provider. The text message may include the call letters of the radio station. The PDN provider may then identify the applicable radio from the text message and access the radio station's play list to identify the currently playing song, a recently played song, or another song played by the radio station. The PDN provider may instruct an online music service to deliver the identified song to the user or make it available for download. The user may then be charged a premium for the message, which premium may be divided appropriately among the parties. The premium may be a fixed-rate premium or may be determined by some other appropriate method.

### DETAILED DESCRIPTION OF THE EMBODIMENTS

In one aspect, the present specification describes a PDN that enables users of a service to order remote products that are advertised by a product advertiser. Many of the service users will carry a wireless communication device that can act as a messaging device. The wireless communication devices may be implemented as mobile telephones, personal digital assistants (PDAs), handheld computers and pagers. When the service user encounters an advertisement and decides to order the product, the user can send a message, called a Product Request Message (PRM) to a PDN provider. For example, the PRM may be a text message sent over short messaging service (SMS) or any other messaging service such as enhanced messaging service (EMS), in which case the destination may be a telephone number. In another example, the PRM may be an instant message (IM), in which case the destination may be a screen name.

When the user sends the PRM to the destination, it may be first received by a communications service provider (CSP), which provides the messaging service over which the user sent the PRM. For example, the CSP may be a telephone company providing mobile phone service, or it may be an internet service provider (ISP) that provides IM services. The PDN provider may be in cooperation with the product advertiser, a product provider, or both. Because certain embodiments allow the user to send only a minimal message, cooperation with the content advertiser or a metadata provider may be needed to fill in missing data based on inherent properties of the message as sent. Once the missing data have been filled in, a product request can be sent to the product provider, who can either deliver the actual product to the user, or make it available.

One exemplary embodiment of a PDN recognizes that one inherent effect of radio broadcasts, including over-the-air, digital, and satellite, is to advertise the songs that are played on the broadcast. So when a user hears a song on the radio, the user may decide to download the song. The present PDN allows the user to do so by sending a PRM in the form of a text message or other form of simple message to a number associated with the PDN. The text message may include nothing more than the call letters of the radio station that the user was listening to. The PDN provider may then query a metadata provider to retrieve the radio station's play list to determine what song was playing when the message was sent. After determining what song was playing, the PDN provider may send a confirmation message to the user to confirm that the user actually intends to purchase the song. The user's affirmative response to the confirmation message may constitute a so-called “double opt-in” (meaning that the user has two separate opportunities to ensure that the request is right), which may be required by law in some cases. After the double opt-in, the service provider may then instruct an online music service to deliver or make available the requested song as a digital download. The mode of delivery may be any of various means, such as “pushing” the content out to the user's broadband-connected media device (such as a computer or portable music player) or providing a hyperlink to the download in a message or e-mail.

Because online music services may provide fixed-price content (for example, one popular service sells all of its songs at a fixed price of $0.99), billing can be simplified by charging the user a premium for the PRM and then dividing the proceeds, as appropriate, between the PDN provider, the CSP, the product advertiser, and/or the product provider. For example, the PDN provider may charge a fixed premium of $1.25 for all messages confirming the purchase of a downloadable song. Users may be willing to pay $0.26 extra for the convenience and immediacy of the order. The PDN provider may divide the $0.26 between itself, the CSP, and the product advertiser, and/or may negotiate a discounted price with the online music service to further increase profits.

In an extension of the embodiment described above, the fixed-rate premium may be variable or temporally variable depending on what is being broadcast at different times. For example, in one time block, the radio station may be broadcasting music, so that anything ordered during that time is billed at $1.25. Later, the station may go to a commercial break. Certain of the goods or services advertised during the break may be available over the PDN, and during the time block when those commercials are played, PRMs will be charged a premium corresponding to the advertised good or service. So, for example, during a commercial break, the radio station may air advertisements for a car detail service, a restaurant, and a new book. During any of those commercials, the user may send a text message with the radio station's call letters, and receive, respectively, a coupon for the detail service, a gift card for the restaurant, and a copy of the new book. During each of those segments, the premium rate charged for a text message is adjusted to reflect the cost of the good or service.

From the user's perspective, billing is greatly simplified. The premium is simply added to the user's regular, periodic bill from the CSP. The user does not need to have any relationship with the radio station except to know its call letter, and the user does not need to have an established account with the PDN provider or product provider. In fact, the user does not even need to know whom the product came from. There is no need to have accounts with multiple providers or try to locate the one with the desired product. The product simply “shows up,” and the user pays the bill when it comes.

From the perspective of the providers, is the disclosed subject matter includes an ability to reach a large target audience that listens to broadcast radio. And because users may be willing to pay more for the convenience of the service, profits can be increased.

In a similar embodiment, the product advertiser may be a television station. The network may operate similar to the operation for a radio station, but instead of songs, movies or episodes of television shows may be delivered to the user.

In yet another exemplary embodiment, metadata and the product may be sold in two separate steps. For example, a PDN provider may contract with a music licensing agent to acquire licenses, either in bulk or on-demand, for digital music files. The PDN provider may also provide an online service, where users may optionally sign up and provide a credit card for billing purposes. The online service may include an “inbox” where messages and links may be stored. At some point, a user may be listening to a radio station such as “WPTO” and hear a new song that the user wants to purchase. The user may then send a text message, which acts as a PRM, to number 12345, which is assigned to a PDN provider. The text of the message may be simply “WPTO,” identifying the station playing the song that the user wants to identify or purchase. The PDN provider may then query a metadata provider, which may be a service that monitors radio stations such as WPTO to determine which songs are playing at certain times. The PDN provider may then send a response text message giving the user two options: Either to purchase the metadata or to cancel. If the user cancels, and if the user has an existing account with the PDN provider, a message may be sent to the user's inbox to give the user the option of later purchasing the metadata. On the other hand, if the user opts to purchase the metadata through the text message interface, then the user may be charged a premium rate for the response message, for example $0.99, which may be added to the user's mobile service bill. The user may then receive a new message, informing the user, for example, “You are listening to ‘Continuation Nation’ by Jerome.” In some embodiments, other metadata may be provided, such as album information, release date, record label, and position on music charts by way of non-limiting example. If the user has an existing account with the PDN provider, a message may also be sent to the user's inbox with the content of the metadata.

Embedded in the metadata message may be options to purchase the song for an additional fee. For example, a first option may be to purchase the song with premium message billing for a first additional amount, for example $1.99, in which case the return message will be billed as a premium message, and the fee will be added to the user's mobile service bill. If the user does not have an existing account, the PDN provider may then provide a text message with a uniform resource locator (URL) link from which the song can be downloaded at a later time. If the user has an account with the PDN provider, a URL link may also be sent to the user's inbox. If the account includes an existing credit card number, a second option may be to purchase the song for a second additional amount, for example $1.49, which may be charged to the user's credit card. In this case, a URL link for downloading the song may be sent to either or both of the mobile phone via text message and the user's inbox. Finally, the user may be given a third option to cancel, in which case there may be no additional charges. If the user cancels, and if the user has an existing online account with the PDN provider, a URL link may be added to the user's online account to provide an opportunity to purchase the song later.

The user's online account with the PDN provider may also provide other services. As a first example, if the user chooses to purchase metadata but not the song identified by the metadata, a message in the inbox may provide, along with the metadata, links to music download services on which the song is available. The links may include comparative pricing information, and may provide links to alternative versions such as live concert recordings or dance mixes. As a second example, the PDN provider may provide a real-time streaming service which could allow the user to stream purchased music from any internet-connected computer. This could allow the user to have instant access to purchased content even when not at his or her primary computer.

In other exemplary embodiments, users may be exposed to other forms of advertising. For example, a PDN may enable a user to order goods from a catalog or other advertisement for physical products. The goods may be identified by product codes, which may be limited to seven or fewer numbers so that they are easy to enter. Each good may then be ordered by sending a PRM wherein the content of the PRM includes or consists entirely of the product code. To preserve the fixed-rate billing model, goods may be divided into certain price classes, with a different phone number being used to order goods from different price classes. For example, users may send a message to Number A to order goods costing $9.99, Number B to order goods costing $19.99, and Number C to order goods costing $29.99. If non-fixed-rate billing is desirable, then the content advertiser may provide the service provider with metadata that includes not only an identification of the product, but also a price. In this case, the confirmation message may include a confirmation of the charge, and the proper premium may be applied to the confirmation message.

In yet another exemplary embodiment, goods with variable prices may be advertised with a product code that includes an embedded price code. The price code can be decoded from the message, and the proper premium can then be applied.

In yet another exemplary embodiment, product codes may be replaced by identifiers inherent to the product. For example, books may include a Library of Congress number. A user who encounters the book may send a PRM with the Library of Congress number. In this case, the product advertiser and metadata provider may be one entity that correlates Library of Congress numbers to available books and identifies a product provider that carries the requested book. The book may then be provided as either a physical delivery or as an electronic book.

A PDN will now be described with more particular reference to the attached figures. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, widget 102-1 may refer to a “pen,” which may be an instance or example of the class of “writing implements.” Writing implements may be referred to collectively as “writing implements 102” and any one may be referred to generically as a “writing implement 102.”

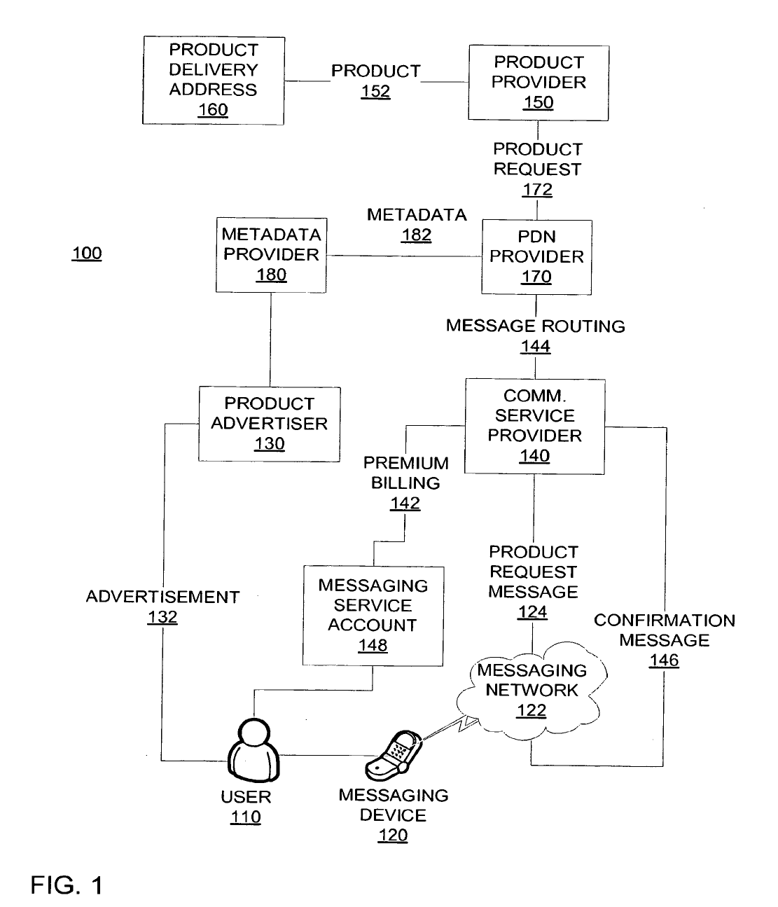

FIG. 1 depicts selected elements of an embodiment of a PDN 100 for processing requests and delivering remote products. A user 110 may encounter an advertisement 132 provided by a product advertiser 130. User 110 may then operate a messaging device 120. Messaging device 120 may be a wireless communication device such as a mobile phone, a personal digital assistant (PDA), a hand-held computer, or any other wireless network-aware device adapted to send and receive messages. In other embodiments, messaging device 120 may communicate via a wireline connection. Messaging device 120 communicates with a messaging network 122, which may be a wireless messaging network. Over the messaging network 122, messaging device 120 sends a product request message (PRM) 124 to a PDN provider 170. PRM 124 may be handled by CSP 140, which provides message routing 144. In some embodiments, PRM 124 includes information that identifies or is otherwise indicative of a requested product 152. PDN provider 170 may communicate with metadata provider 180 and product provider 150. Metadata provider 180 may monitor product advertiser 130 or be otherwise associated therewith. As depicted in FIG. 1, metadata provider 180 provides metadata 182 to PDN provider 170. Metadata 182 may enable CSP 140 to identify requested product 152. When PDN provider 170 has identified the requested product 152, PDN provider 170 may send a confirmation message 146, thus providing a double opt-in method for requesting product 152. In response to either PRM 124 or confirmation message 146, CSP 140 may apply premium billing 142 to the user's service account 148 and remit all or a portion thereof to PDN provider 170 according to an agreement. Service provider 140 may then generate and deliver a product request 172 identifying requested product 152 to product provider 150. In response to receiving or otherwise detecting product request 172, product provider 150 may deliver requested product 152 to a product delivery address 160. In an alternative embodiment, product provider 150 may also fill the role of PDN provider 170.

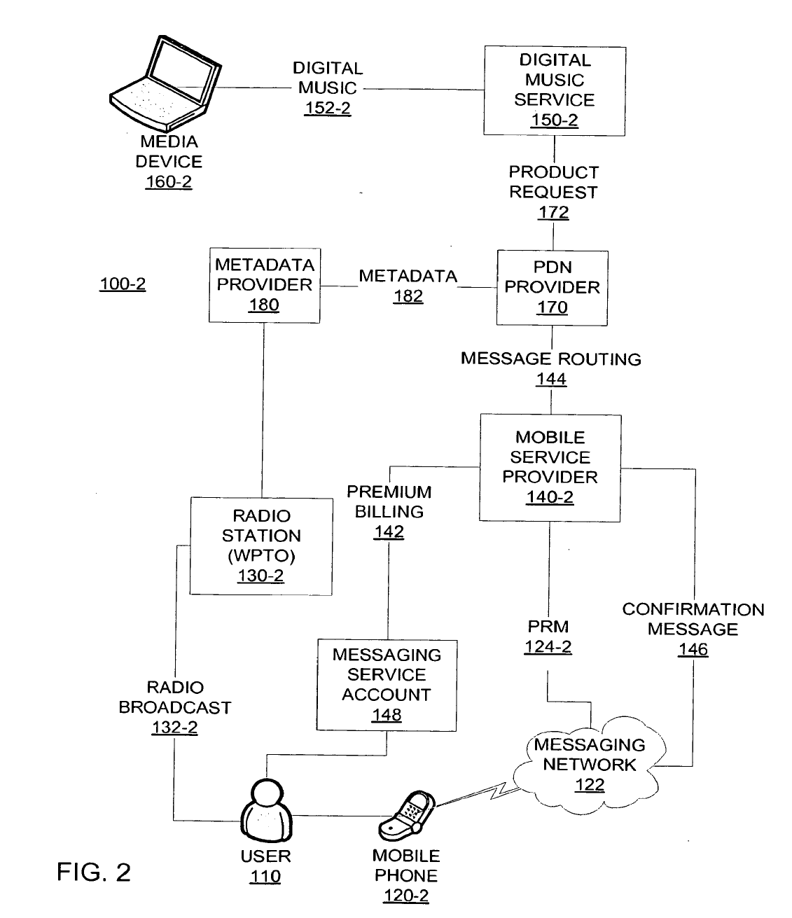

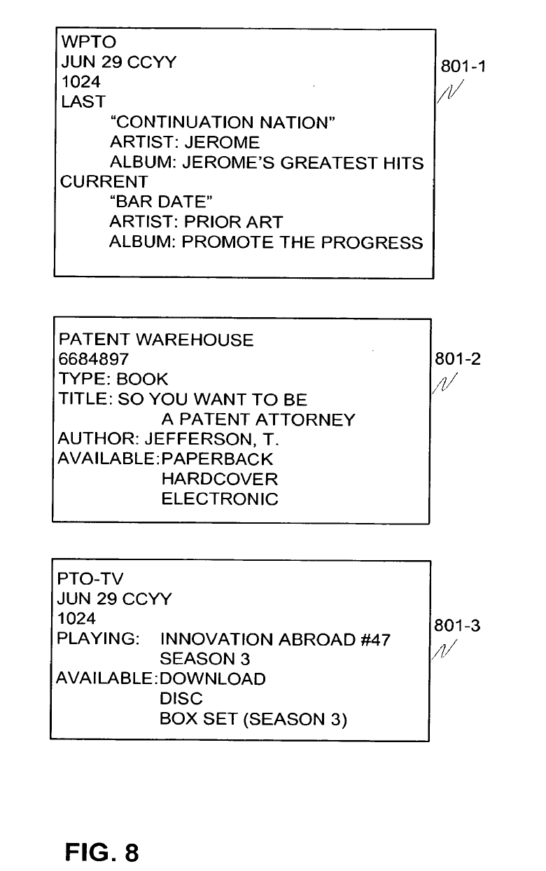

FIG. 2 illustrates selected elements of an exemplary embodiment of a PDN 100 useful for ordering or otherwise acquiring digital music. In the depicted embodiment, user 110 may be listening to radio station WPTO 130-2. User 110 will hear radio broadcast 132-2 which may include a song that user 110 wants to download. Using messaging device 120-2, which may be a mobile phone in this case, user 110 sends a PRM 124-2, which may be an SMS or other type of text message, and which is routed via messaging network 122 to PDN provider 170 by mobile service provider 140-2. Mobile service provider 140-2 may comprise more than one entity, for example it may include both a mobile phone company and a messaging gateway service. Mobile service provider 140-2 may apply a time stamp to the message 124-2 and deliver message 124-2 to PDN provider 170. PDN provider 170 may then request and receive metadata 182 from metadata provider 180. Metadata 182 may include a data structure containing information uniquely identifying one ore more songs played by a radio station, and further including time information indicating when at least one of the songs was played. An example is shown as 801-1 (FIG. 8). PDN provider 170 can then identify which song radio station WPTO 130-2 was playing when PRM 124-2 was sent. PDN provider 170 may then send product request 172, in which the requested product 152-2 is the identified song. Digital music service 150-2 may receive product request 172 and provide the requested product 152-2, which is the identified song, for download to the user's media device 160-2. In an alternative to this embodiment, digital music service 150-2 may also act as PDN provider 170.

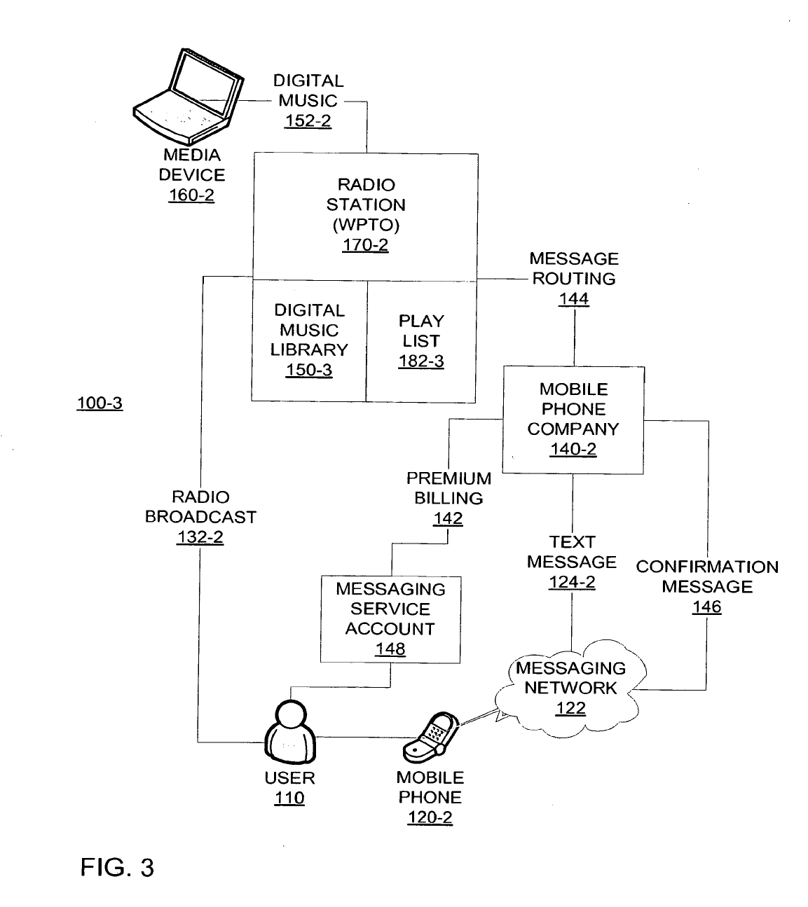

FIG. 3 provides another alternative embodiment of PDN 100. In this embodiment, radio station WPTO 170-2 may maintain a digital music library 150-3, including digital copies of songs that it regularly plays, and an internal play list 182-3. In this embodiment, radio station WPTO 170-2 encompasses the functions of product advertiser, metadata provider and PDN provider. This configuration illustrates that any combination of CSP, product advertiser, PDN provider, and/or product provider may be combined in a single entity. In the depicted embodiment, the integration of product provider, metadata provider, PDN provider, and product advertiser may be practical because many radio stations have a limited number of songs in rotation at any given time. By maintaining a digital library of those limited number of songs, a radio station may be able to deliver any requested song without maintaining a library of millions of songs such as some dedicated digital music services may do.

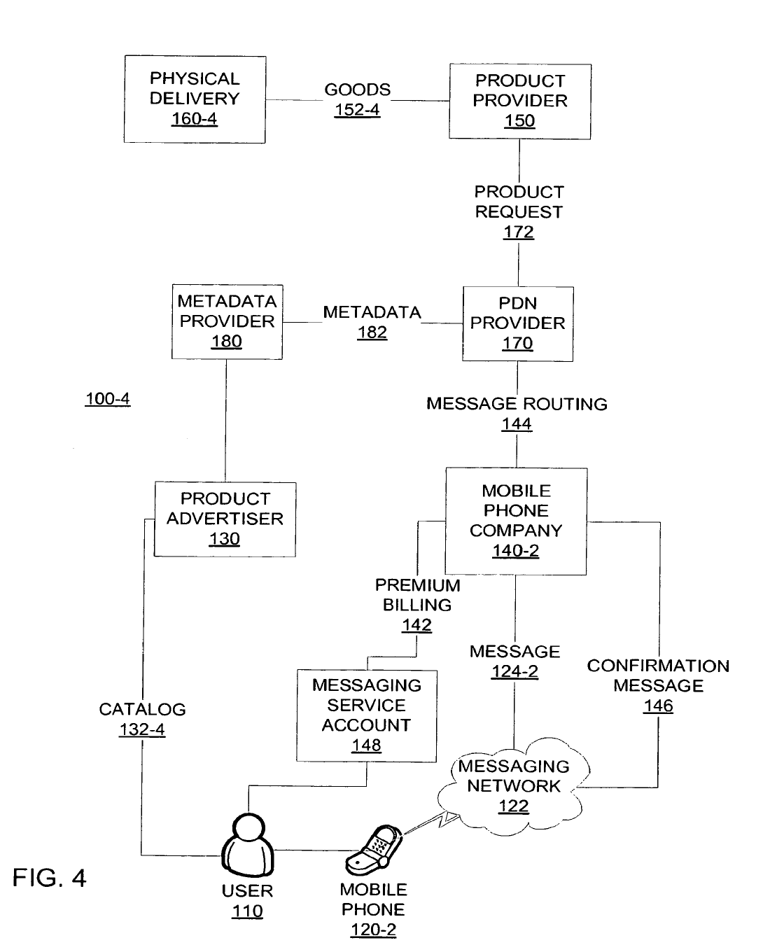

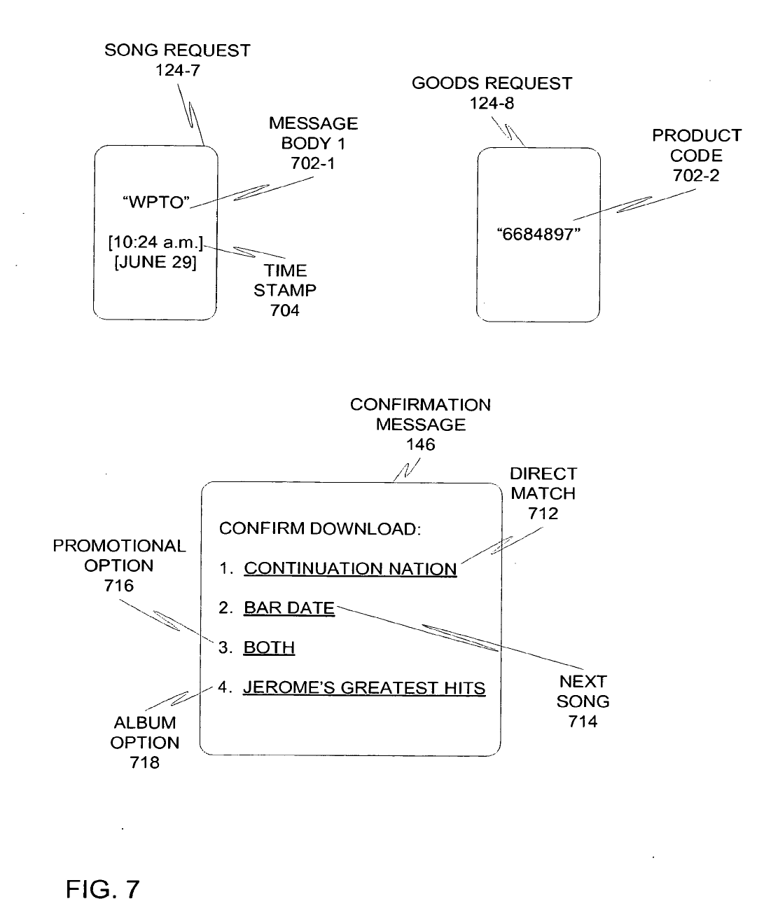

FIG. 4 illustrates selected elements of an embodiment of a PDN 100 useful when a requested product is a physical good. In the depicted embodiment, a product advertiser 130 provides advertisement, for example through a catalog 132-4. User 110 may receive catalog 132-4, and find desirable goods. The goods in catalog 132-4 may be divided into fixed-price categories, and/or associated with a product code 702-2 (FIG. 7). In this case, the content of message 124-2 may include the product code 702-2 (FIG. 7). PDN provider 170 may then query metadata provider 180, which in some cases may be product advertiser 130 to receive metadata 182 formatted to identify the requested goods. The confirmation message 146 may then ask the user to confirm the order for the requested goods. If the user confirms, then premium billing 142 may be applied to the user's service account 148 according to the category of goods ordered. A product request 172 is then formatted and sent to product provider 150, which provides requested goods 152-4 for physical delivery 160-4 to a given address.

This embodiment may be particularly useful when a product provider 150 makes a certain group of goods 152-4 available at a common fixed price. For example, product provider 150 may have a catalog of goods all available for a fixed price of $19.95.Any of these goods could then be ordered via message 124-2, which may be a text message or other type of message, simply by including the product code 702-2 (FIG. 7). This would enable the user 110 to order the goods even if he did not have an established account with the product provider 150. In this case, PDN provider 170 may provide the service while mobile phone company 140-2 could handle billing and may divide the proceeds of the premium billing 142 between itself, product advertiser 130, product provider 150, metadata provider 180 and PDN provider 170 as appropriate.

On the other hand, if a product provider 150 needs to designate multiple categories of goods (for example, a first category of goods costing $9.95, a second category of goods costing $19.95, and a third category of goods costing $29.95), each category of goods may be associated with a separate telephone number. The user may then acquire goods in one of the categories by sending a message 124-2 to the appropriate number.

In an alternative embodiment, one telephone number may be designated for ordering goods from any class. In this embodiment, the product code 702-2 (FIG. 7) itself may be encoded to indicate the category of goods. In yet another alternative embodiment, the product code 702-2 (FIG. 7) may be encoded with the price of the goods. In either of these cases, rather than charging a fixed premium for the message, mobile phone company 140-2 and/or PDN provider 170 may dynamically assign a premium based on the content of the message.

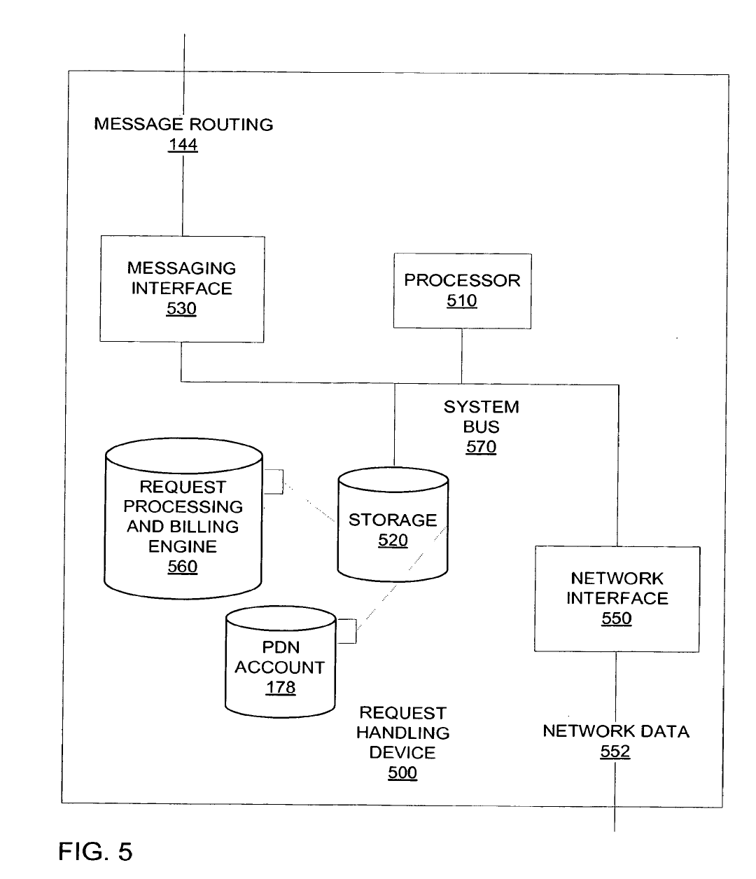

FIG. 5 is a block diagram of a request handling device 500. The request handling device 500 may be programmed with the logic necessary for receiving PRM 124, receiving metadata 182, generating an appropriate product request 172, and calculating premiums for billing purposes. In some embodiments, request handling device 500 may reside within or be operated by PDN provider 170. Request handling device 500 includes a processor 510 connected to a system bus 570, which allows communication between various components of request handling device 500. Storage 520 includes data that represent a user's PDN account 178. Storage 520 is communicatively coupled to processor 510 via system bus 570. A messaging network interface 530 communicatively couples processor 510 to a messaging network 122 such as may be operated by CSP 140, and allows the request handling device 500 to receive a PRM 124. A network interface 550 allows request handling device 500 to communicate with external networks to enable functions such as requesting metadata 182 (FIG. 1) and sending product requests 152 (FIG. 1). In some configurations, messaging network interface 530 and network interface 550 may be a single device performing both functions. A request processing and billing engine 560 may be implemented in hardware or in software, and may be an integrated component or a separate component. Request processing and billing engine 560 may include the logic to receive requests, process requests, initiate the necessary communication with other parts of the network, and apply the appropriate charges to the user's service account.

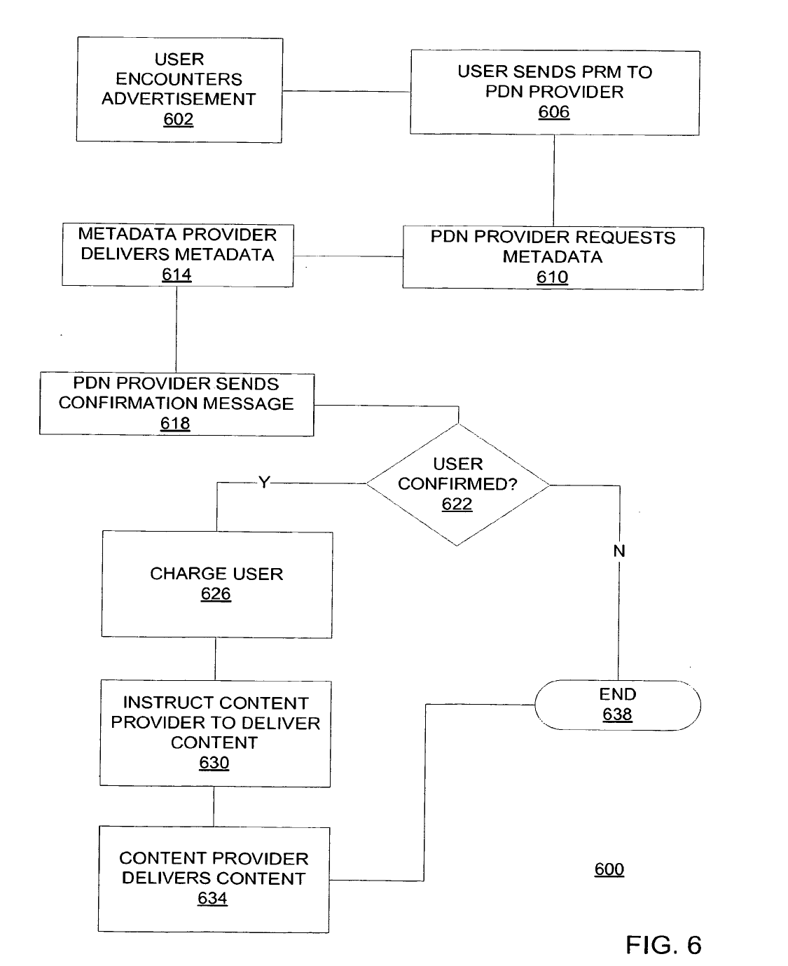

FIG. 6 is a flow diagram showing selected elements of an embodiment of a method 600 of processing requests and delivering remote products. In block 602 user 110 (FIG. 1) encounters an advertisement 132 (FIG. 1) or other form of content. In block 606, user 110 (FIG. 1) sends a PRM 124 (FIG. 1) to PDN provider 170 (FIG. 1). In block 610, PDN provider 170 (FIG. 1) requests metadata 182 (FIG. 1). In block 614, metadata provider 180 (FIG. 1) delivers metadata 182 (FIG. 1) to PDN provider 170 (FIG. 1). In block 618, PDN provider 170 (FIG. 1) sends a confirmation message 146 (FIG. 1) to user 110 (FIG. 1). Block 622 is a check to see whether user 110 (FIG. 1) confirmed. If not, then in block 638, no further action is taken. If user 110 (FIG. 1) did confirm in block 622 then PDN provider 170 (FIG. 1) charges user 110 (FIG. 1) in block 626. In block 630, PDN provider 170 (FIG. 1) sends a product request 172 (FIG. 1) to product provider 150 (FIG. 1), instructing product provider 150 (FIG. 1) to deliver product 152 (FIG. 1). In block 634, product provider 150 (FIG. 1) delivers product 152 (FIG. 1) to the product delivery address 160 (FIG. 1) and then, in block 638, method 600 ends.

FIG. 7 illustrates exemplary embodiments of messages 124 for use with a PDN. Song request 124-7 is an example of PRM 124. Each PRM 124 may have a message body 702. In this example, message body 1 702-1 is a string of call letters, in this case the string WPTO, identifying the radio station on which the user heard a song that he or she wants to download. There is also appended to the song request 124-6 a time stamp 704. Time stamp 704 allows service provider 140 (FIG. 1) to correlate song request 124-7 to a song that was playing when song request 124-7 was sent.

A second example of a PRM 124 is provided as a request for goods 124-8. This type of message may be used in conjunction with the embodiment described in FIG. 4. In this case, PRM 124 (FIG. 1) is a request for goods 124-8 and message body 702-2 is composed of a product code, in this case the arbitrary product code 6684897, which would identify some good that the user has seen in the catalog and wants to order. It may be desirable to limit the length of the product code to make use of it easier for user 110 (FIG. 1). For example, it may be desirable to limit product code 702-2 to seven or fewer characters.

FIG. 7 also shows an example of a confirmation message 146 such as might be sent in response to song request 124-7. In some embodiments, the confirmation message may be an SMS text message or a message in a more advanced protocol such as enhanced messaging service (EMS). For purposes of illustrating this example, assume that radio station WPTO 130-2 (FIG. 2) was playing the hit song “Continuation Nation” at 10:21 a.m., followed by another song, “Bar Date,” at 10:24 a.m. As shown by the time stamp 704, the message was sent at 10:24 a.m. PDN provider 170 may receive metadata 182 from metadata provider 180 to determine that at 10:24 a.m. “Bar Date” was playing on radio station WPTO 130-2 (FIG. 2). Recognizing that a text message may be somewhat delayed, the confirmation message offers not only an option to confirm downloading “Bar Date” but also the song that preceded it on WPTO 130-2 (FIG. 2), “Continuation Nation.” So if PRM 124 (FIG. 1) is delayed, or if user 110 (FIG. 1) waits until the end of the song to request the download, user 110 (FIG. 1) will still be able to get the desired song. This confirmation message also shows promotional options that may be provided. For example, option 3 is a promotional option 716 that allows user 110 (FIG. 1) to download both songs. A fourth option would be an album option 718 which allows user 110 (FIG. 1) to download the entire album “Jerome's Greatest Hits,” which includes the hit song “Continuation Nation” 712.

FIG. 8 illustrates exemplary embodiments of metadata packets 801 such as might be sent in metadata 124 (FIG. 1). First example 801-1 may be useful for an embodiment enabling delivery of digital music, such as is illustrated in FIG. 2. In this embodiment, metadata packet 801-1 is configured to enable service provider 140 (FIG. 1) to allow user 110 (FIG. 1) to receive a song. Packet 801-1 indicates that the broadcast station identifier “WPTO” was sent on June 29, CCYY at 10:24 a.m. The song currently playing is “Bar Date” by the artist Prior Art, from the Album “Promote the Progress.” Packet 801-1 also identifies the previous song, “Continuation Nation” by the artist “Jerome,” from the album “Jerome's Greatest Hits.” This example illustrates a purpose of sending both the current song and a previous song. At 10:24, “Bar Date” may have just started, so there are two strong possibilities: First, that user 110 (FIG. 1) just finished listening to “Continuation Nation” and decided to download it. Second, that user 110 (FIG. 1) is familiar with “Bar Date,” has been waiting for it to play, and sent a message immediately upon hearing it. With this information, service provider 140 (FIG. 1) can allow user 110 (FIG. 1) to receive either or both of the songs, and can also provide other promotional options such as album downloads.

Packet 801-2 illustrates metadata that may be useful in ordering physical goods, such as a book. In this example, user 110 (FIG. 1) may have seen a catalog from Patent Warehouse and found a desirable book, T. Jefferson's So You Want to Be a Patent Attorney. User 110 (FIG. 1) may have sent a PRM 124 (FIG. 1) with the string 6684897, which corresponds to the desirable book. Packet 801-2 indicates that the book is available as a paperback, hardcover, or as an e-book.

Packet 801-3 illustrates metadata that may be useful in ordering a television program that user 110 (FIG. 1) saw while watching PTO-TV. In this example, user 110 (FIG. 1) may have seen an episode #47 of the television show “Innovation Abroad” and decided to order it. Packet 801-3 indicates that the string “PTO-TV” was sent at 10:24 a.m. on June 29, CCYY. Episode #47 of “Innovation Abroad” was playing, which is an episode from season 3. The episode may be available as a download, on physical media such as on a disc, or as part of a box set including all of season 3.

In some alternative embodiments of the above examples, the various delivery options provided may have different prices. So metadata packet 801 may also include appropriate price information for each option.

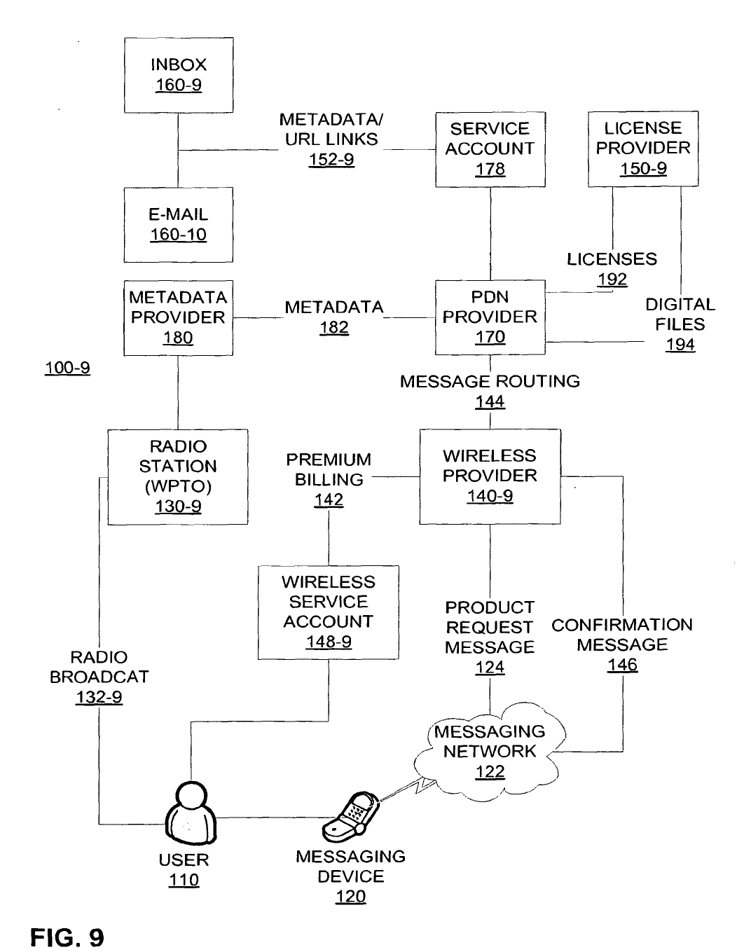

FIG. 9 is a network diagram showing selected elements of an embodiment of a PDN 100-9. This embodiment specifically illustrates a method that may be used for advertising and selling digital music, and wherein the product may be provided either as metadata or digital content. This embodiment is similar, in some respects to the embodiment disclosed in FIG. 2. User 110 may listen to a radio broadcast 132-9 from radio station WPTO 130-9. If user 110 hears a song and wants to purchase the metadata and/or digital song, the user 110 may send a PRM 124 to PDN provider 170, which is handled by wireless provider 140-9. Wireless provider 140-9 provides message routing 144, delivering PRM 124 to PDN provider 170. PDN provider 170 requests metadata 182 from metadata provider 180, which may be a service that monitors radio stations like WPTO 130-9. PDN Provider 170 may send a confirmation message 146, which may provide user 110 an option to purchase as product 152-9 either metadata for the song, or a digital version of the song, which may be delivered as a URL to linking the user to the purchased content. Product 152-9 may be provided as a message or link in user 110′s inbox 160-9, as an e-mail 160-10, or in a confirmation message 146.

In order to provide digital downloads, PDN provider 170 may contract with a license provider 150-9, which may provide blanket or individual licenses 192 to certain recordings, and may also provide the actual digital files 194. Licensing through license provider 150-9 may simplify licensing of copyrights in digital songs and permit PDN provider 170 to operate without keeping a large library of digital files. But embodiments as disclosed in FIG. 9 do not require the use of a separate license provider 150-9. PDN provider 170 may instead assume this function itself in some embodiments.

In FIG. 9, it is also apparent that user 110 may have an existing PDN account 178 with PDN provider 170. This may provide some flexibility in billing. A user 110 may be billed a premium by means of a confirmation message 146, which may be charged to the user 110′s wireless service account 148-9, or if a credit card number has been entered for use with PDN account 178, the credit card may be charged.

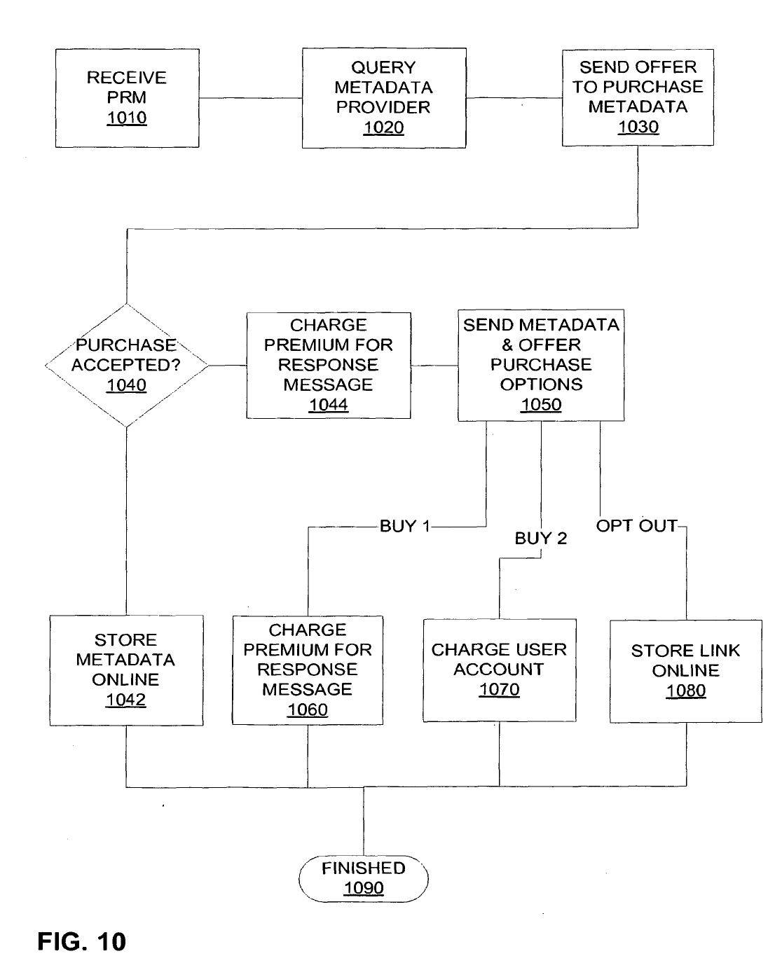

FIG. 10 is a flow diagram disclosing a method of operating a PDN to permit a user 110 to purchase metadata and digital content separately. This method may be used in some embodiments, including the embodiment disclosed in FIG. 9. In block 1010, a PRM is received identifying, for example, call letters for radio station WPTO. In block 1020, the metadata provider is queried to retrieve metadata associated with the PRM. For example, metadata may identify the song playing on radio station WPTO when the PRM was sent. In block 1030, the user is offered an option to purchase the metadata. In block 1040, if the purchase is not accepted, then in block 1042, a copy of the metadata may be stored online to facilitate, for example, providing user 110 a message in an inbox to allow user 110 to choose to purchase the metadata later. In block 1044, if user 110 chooses to purchase the metadata, then a premium message charge may be applied to the message. As an alternative, if user 110 has an existing service account 178, a credit card may be charged for the metadata 182. In block 1050, if user 110 purchases the metadata, a new message may be sent including the metadata and an option to purchase the product, for example, a digital file. In block 1060, user 110 may be offered an opportunity to purchase the digital file for a first amount via premium text message, in which case the charge may be applied to user 110′s mobile telephone bill.

While the disclosed subject matter has been presented in connection with one or more exemplary embodiments, the claimed subject matter is not limited by the disclosed embodiments. On the contrary, the claimed subject matter it is intended to cover such alternatives, modifications, and equivalents as may be included within the spirit and scope of the disclosure.

What is claimed is:

1. A method of making a desired product available for purchase to a user of a telecommunication service, the method comprising:
receiving a product request message (PRM) from a mobile device, the PRM comprising a product identifier;
determining the desired product from the PRM;
sending a product request to a product provider, the product request instructing the product provider to deliver the product; and
charging a premium to a user's account with the telecommunication service.

2. The method of claim 1, wherein the premium is charged to the user's account in response to the PRM.

3. The method of claim 2, wherein the premium is a fixed-rate premium

4. The method of claim 1:
further comprising receiving, from the user, a response to a confirmation message; and
wherein the premium is charged to the user's account after receiving the confirmation message response.

5. The method of claim 4, wherein the premium is a fixed-rate premium.

6. The method of claim 1, further comprising correlating the product identifier to the product including receiving metadata from a product advertiser.

7. The method of claim 6, wherein:
the product advertiser is a broadcaster;
the product identifier is a station identifier assigned to the broadcaster; and
the metadata comprise information identifying an advertisement broadcast substantially simultaneously with delivery of the PRM.

8. The method of claim 7, wherein the advertisement comprises a song available for electronic delivery.

9. The method of claim 7, wherein the advertisement advertises a physical product available for delivery.

10. The method of claim 1, wherein the service provider and the product provider are a single entity.

11. A software program comprising computer-executable instructions stored on a tangible computer-readable medium communicatively coupled to a request handling device, the software program comprising instructions to:
receive a product request message (PRM);
receive metadata associated with the PRM;
identify a product from the PRM and metadata;
send a product request instructing a product provider to deliver the product; and
charge a premium to a user account with a telecommunication service provider.

12. The software program of claim 11, wherein the PRM identifies a broadcast station.

13. The software program of claim 11 wherein:
the PRM comprises a station identifier and a time stamp; and
the metadata identifies a song playing on a station identified by the station identifier at a time correlating to the time stamp.

14. The software program of claim 11 wherein:
the PRM comprises a product code; and
the metadata identifies a product correlating to the product code.

15. A request handling device comprising:
a processor enabled to access storage, the storage including data representing a user's service account;
a messaging network interface communicatively coupling the processor to a messaging network; and
a queuing and billing engine adapted to:
receive a message from the messaging network interface;
charge a premium to the user's service account in response to the message; and
order a product to be delivered to the user.

16. The device of claim 15 wherein the premium is a fixed-rate premium.

17. The device of claim 15 wherein the product is a digital file.

18. The device of claim 15 wherein the product is a good.

19. A product distribution network (PDN) comprising:
a PDN provider;
wherein the service provider is adapted to:
receive a product request message (PRM) from a user;
receive metadata from a product advertiser, the metadata enabling the service provider to correlate the PRM to a product; and
deliver a product request to a product provider.

20. The network of claim 19 wherein the product advertiser is adapted to:
deliver an advertisement to the user; and
deliver metadata to the service provider.

21. The network of claim 19 wherein the product provider is adapted to:
receive a product request from the service provider; and
deliver a product to the user.

22. The network of claim 21 wherein:
the product comprises electronic data; and
the product is delivered over a data network.

23. The network of claim 21 wherein:
the product comprises goods; and
the product is delivered to a physical location.

24. A product distribution method, comprising:
receiving a product request message from a user;
receiving metadata from a metadata provider, wherein the metadata identify attributes of a product associated with the product request message;
making an offer to the user to purchase at least a part of the metadata;
delivering the offered part of the metadata on the user's acceptance of the offer to purchase the part of the metadata; and
making an offer to the user to purchase a product identified by the metadata.

25. The method of claim 24 wherein the offer to purchase the product includes a plurality of purchase options.

26. The method of claim 25 wherein a first purchase option is associated with a first billing method and a second purchase option is associated with a second billing option.

27. The method of claim 26 wherein the first billing method is a premium charge for a text message and the second billing option is a charge to an account for the user.
